(19) United States
(12) Patent Application Publication
(10) Pub. No.: US 2009/0260847 A1
(43) Pub. Date: Oct. 22, 2009

(54) Data Transmission Cable and Method for Producing a Data Transmission Cable

(75) Inventors: Gerold Tobben, Friesoythe (DE); Bernd Janssen, Neuscharrel (DE)

Correspondence Address: LERNER GREENBERG STEMER LLP, P O BOX 2480, HOLLYWOOD, FL, 33022-2480, US

(73) Assignee: LEONI KABEL HOLDING GMBH, Nurnberg (DE)

(21) Appl. No.: 12/427,389

(22) Filed: Apr. 21, 2009

(30) Foreign Application Priority Data
Apr. 21, 2008 (DE) 102008019968.0-34

(51) Int. Cl. H01B 11/00; H01B 13/22

(52) U.S. Cl. 174/107; 156/52

(57) ABSTRACT

A data transmission cable (2) comprises at least one pair of wires (4) comprising two wires (6) lying parallel to each other, each with an electrical conductor (8) surrounded by an insulation (10). The pair of wires (4) is sheathed over its length by a foil (12) with an electrically conducting inner side (14) and an electrically insulating outer side (16). To improve the electrical properties of the data transmission cable (2), the foil (12) has a longitudinal fold (18), so that the inner side (14) is directed outward, an additional wire (20), which contacts the inner side (14) made to face outward, being laid on the foil (12).

The invention relates to a data transmission cable with at least one pair of wires comprising two wires lying parallel to each other, each with an electrical conductor surrounded by an insulation, the pair of wires being sheathed over its length by a foil with an electrically conducting inner side and an electrically insulating outer side. The invention also relates to a method for producing such a data transmission cable.

A data transmission cable according to the precharacterizing clause of the main claim is disclosed, for example, by DE 199 48 678 A1. The figures in this document show a data transmission cable which includes at least one pair of wires consisting of two wires. Each wire comprises an electrical conductor, in particular made of copper, which is embedded in an insulating material. In addition, the pairs of wires are enclosed by a shielding, for instance an aluminum-laminated foil. The data transmission cable according to the prior art also has an additional wire known as a reserve wire, which may be arranged at different locations in the cable. The additional wire serves here for the direct electrical connection of the shielding of the pair of wires to the ground reference potential and ensures that the shielding is reliably connected to the reference potential over the entire length of the line. Such a data transmission cable is sold by the applicant under the name “ParaLink” and is used, for example, in the field of radiofrequency technology.

U.S. Pat. No. 4,323,721 discloses a data transmission cable with two wires twisted together, each of the wires being surrounded by a shielding which is laid in the manner of a helically wound figure of eight on its side, so that the wires are separated from one another by the shielding.

The invention is based on the object of providing a data transmission cable with improved electrical properties.

The object is achieved according to the invention by a data transmission cable with at least one pair of wires comprising two wires lying parallel to each other, each with an electrical conductor surrounded by an insulation, the pair of wires being jointly sheathed in an annular manner over its length by a foil with an electrically conducting inner side and an electrically insulating outer side, the foil having a longitudinal fold, so that the inner side is directed outward, and an additional wire being laid on the foil and contacting the inner side made to face outward. The wires of the pair of wires run parallel to each other, which is to be understood in particular as meaning that the wires lie against each other but are not twisted together. The two wires in this case lie with their insulations directly against each other and are jointly enclosed in an annular manner by the foil. Enclosed in an annular manner is generally understood as meaning that—seen in cross section—the foil forms an inner space in which the pair of wires lies, without being separated by the foil. The foil encloses an inner space with, in particular, an approximately elliptical cross-sectional area.

The invention is based on the consideration that particularly good electrical properties of a data transmission cable are achieved by the additional wire lying outside the shielding foil and contacting the electrically conducting side of the foil over the entire length of the cable. To achieve this, during the production of the cable, a shielding foil which has a longitudinal fold is used for the joint sheathing of the pair of wires, so that the electrically conducting inner side is directed outward. A longitudinal fold is understood as meaning an outwardly directed fold of an edge region of the foil, the fold extending over the entire length of the foil and keeping to approximately the same width. When the additional wire is laid on, it contacts the electrically conducting inner side along the entire longitudinal fold. Such positioning of the additional wire outside the foil makes a symmetrical construction possible within the shielding and is reflected in the electrical properties of the cable, so as to avoid disturbances in the signal transmission caused by an unsymmetrical cable construction.

The foil is a foil that is easy to produce, one side of which is electrically insulating throughout and the other side of which is electrically conducting throughout. For this purpose, the foil has a backing material, on one side of which a coating is completely applied. The backing material is preferably conducting and the coating comprises an insulating material.

To achieve a particularly secure arrangement of the additional wire, it is preferably fixed between the foil and a sheathing. The sheathing thereby encloses the pair of wires and the additional wire and fixes their position in relation to one another, irrespective of the bending of the data transmission cable.

It is expedient for the sheathing to be an adhesive film. By means of the adhesive film, the additional wire is securely fixed in a particularly easy way.

According to a preferred development, the sheathing is a braid. Such a braid improves the mechanical confinement of the pair of wires and the additional wire enclosed by it and also improves the electromagnetic compatibility of the shielding.

The foil is preferably a plastic-coated aluminum foil. Here, the electrically conducting aluminum side is directed inward toward the pair of wires.

The additional wire is advantageously arranged in an interstitial region between the two other wires. A particularly symmetrical configuration of the data transmission cable is formed in this way. Alternatively, it is possible to attach the additional wire laterally to the pair of wires, the longitudinal fold also being correspondingly arranged.

The data transmission cable preferably has a number of the pairs of wires described above, each pair being assigned an additional wire. Here, each pair of wires is sheathed by a foil which has a longitudinal fold, so that the assigned additional wire is in contact with the electrically conducting inner side of the foil.

The object is also achieved according to the invention by a method for producing a data transmission cable with at least one pair of wires comprising two wires lying parallel to each other, each with an electrical conductor surrounded by an insulation, in which
a longitudinal fold is formed on a foil with an electrically conducting inner side and an electrically insulating outer side, so that the inner side is directed outward,
the pair of wires is sheathed over its length by the foil, and
an additional wire, which contacts the inner side made to face outward, is laid onto the foil.

The foil is preferably first provided with the longitudinal fold and then the foil and the pair of wires are brought together jointly and parallel in a continuous process. Neither the pair of wires nor the foil is twisted. The pair of wires is in this case placed together on the foil, and then the foil is joined in an overlapping manner along the longitudinal fold. This makes it possible for the data transmission cable to be produced as a “continuous cable” in a simple, continuous production process.

The advantages and preferred embodiments that have been presented with respect to the data transmission cable can be applied analogously to the method for producing the data transmission cable.

An exemplary embodiment of the invention is explained in more detail with reference to a schematic drawing, in which:

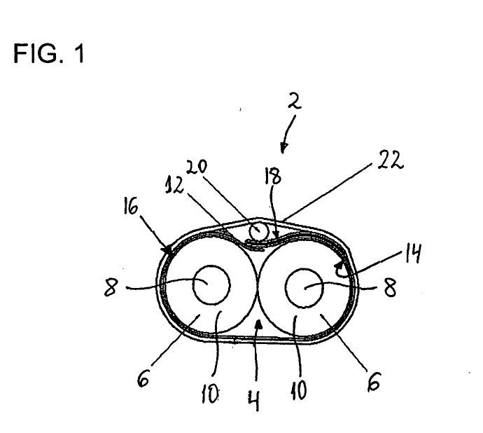

FIG. 1 shows a cross section through a data transmission cable, and

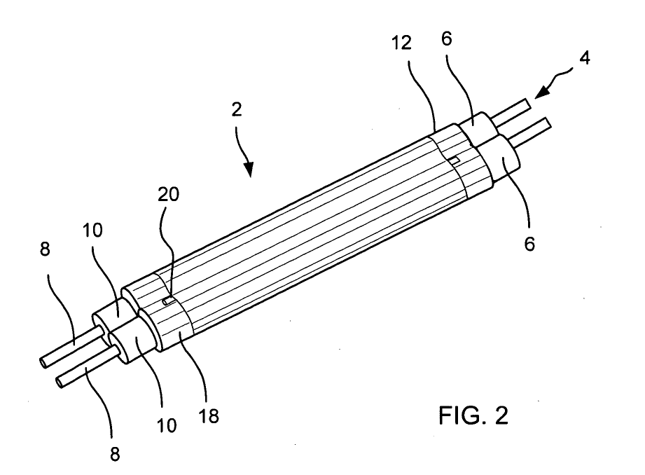

FIG. 2 shows a perspective representation of the data transmission cable according to FIG. 1.

The same designations have the same meaning in the different figures.

FIG. 1 and FIG. 2 show a data transmission cable 2, which in this exemplary embodiment comprises a single pair of wires 4 comprising two wires 6 running parallel to each other. Each of the wires 6 has an electrical conductor 8, which is surrounded by an insulation 10. The wires 6 lie with their insulations 10 against each other. The pair of wires 4 is sheathed over its length by a foil 12, which in this exemplary embodiment comprises an electrically conducting inner side 14, formed from aluminum, and an electrically insulating outer side 16, formed from PET.

When producing the data transmission cable 2, in a first step a longitudinal fold 18 is formed on the foil 12, so that the inner side 14 is directed outward. In a further production step, the pair of wires 4 is sheathed over its length by the foil 12, which serves for shielding. This takes place in particular in a continuous process for the production of a continuous cable. The pair of wires 4 is fed to the foil 12, prepared with the longitudinal fold 18, while parallel, that is to say without twisting, in the longitudinal direction in a continuous process. The foil 12 and the pair of wires 4 are therefore brought together continuously. In this case, the longitudinal fold 18 extends approximately in an interstitial region between the two wires 6 parallel to the latter over the entire length of the cable. In the interstitial region, the ends of the foil 12 overlap. In the exemplary embodiment shown, the folded-around partial region of the foil 12 only extends over part of the transverse dimension of the cable 2, in particular for instance only over the diameter of one wire 6. The data transmission cable 2 also comprises an additional wire 20, which is positioned outside the shielding of the pair of wires 4. The additional wire 20 extends over the entire length of the pair of wires 4 and is laid on the fold 18 of the foil 12, so that it is always in contact with the electrically conducting inner side 14 of the foil 12. The additional wire 20 is preferably likewise fed continuously. Finally, the additional wire 20 is fixed by means of a sheathing 22 on the longitudinal fold 18 of the foil 12. According to the exemplary embodiment shown, the sheathing 22 is an adhesive film, which completely encloses the pair of wires 4, the foil 12 and the additional wire 20. The adhesive film is spun around to form the sheathing 22, i.e. it is wound around the pair of wires 4 like a spiral.

As an alternative to the adhesive film, the sheathing may comprise a braid, which is spun around the pair of wires 4 and the additional wire 20 by machine after the positioning of the additional wire 20 on the longitudinal fold 18. The braid itself may also be formed by adhesive films.

According to an alternative embodiment, the data transmission cable 2 may include a number of pairs of wires 4, which are in each case sheathed by a longitudinally folded foil 12 and have an additional wire 20. The additional wire 20 of each pair of wires is fixed in the interstitial region between the two wires 6 by a sheathing 22.

To complete the data transmission cable 2, a joint cable jacket (not shown in any more detail in the figures), for example made of PVC, is applied around the pair or pairs of wires 4.

1-9. (canceled)

10. A data transmission cable, comprising:
at least one wire pair with two wires lying parallel to each other, each of said wires having an electrical conductor surrounded by an insulation;
a foil annularly encasing said wire pair jointly over a length thereof, said foil having an electrically conductive inner side and an electrically insulating outer side;
said foil having a longitudinal fold exposing a portion of said inner side outwardly; and
an additional wire laid on said foil and contacting said portion of said inner side facing outward.

11. The data transmission cable according to claim 10, which further comprises a sheathing surrounding said foil and fixing said additional wire between said foil and said sheathing.

12. The data transmission cable according to claim 11, wherein said sheathing is an adhesive film.

13. The data transmission cable according to claim 11, wherein said sheathing is a braid.

14. The data transmission cable according to claim 10, wherein said foil is a plastic-coated aluminum foil.

15. The data transmission cable according to claim 10, wherein said additional wire is arranged in an interstitial region between said two wires of said wire pair.

16. The data transmission cable according to claim 10, wherein said at least one wire pair is one of a plurality of wire pairs each having assigned thereto a respective said additional wire.

17. A method of producing a data transmission cable with at least one wire pair having two wires lying parallel to one another and each being formed of an electrical conductor surrounded by an insulation, the method which comprises:
providing a foil with an electrically conducting inner side and an electrically insulating outer side;
forming a longitudinal fold on the foil so that the inner side is directed outward;
jointly sheathing the wire pair with the foil annularly over a length of the wire pair; and
laying an additional wire onto the foil in contact with the inner side of the foil made to face outward.

18. The method according to claim 17, which comprises bringing the foil and the wire pair together jointly and parallel in a continuous process.
